(19) United States
(12) Patent Application Publication
(10) Pub. No.: US 2016/0245768 A1
(43) Pub. Date: Aug. 25, 2016

(54) ELECTRONIC DEVICE INCLUDING FLUID DETECTING DEVICE

(71) Applicant: Samsung Electronics Co., Ltd., Gyeonggi-do (KR)

(72) Inventors: Min-Chang SHIM, Seoul (KR); Ju-Ho YI, Gyeonggi-do (KR); Uy-Hyeon JEONG, Gyeonggi-do (KR); Hyun-Mi CHEONG, Gyeonggi-do (KR); Jae-Shik KIM, Gyeonggi-do (KR); Min-Sung LEE, Gyeonggi-do (KR); Byung-Gun JANG, Gyeongsangbuk-do (KR); Jea-Moon JUNG, Gyeonggi-do (KR)

(21) Appl. No.: 14/982,605

(22) Filed: Dec. 29, 2015

(30) Foreign Application Priority Data
Feb. 25, 2015 (KR) 10-2015-0026690

(51) Int. Cl. G01N 27/12; H04B 1/3888

(52) U.S. Cl. CPC G01N 27/121; H04B 1/3888

(57) ABSTRACT

An electronic device may include: a housing having an interior space within the housing; at least one electronic component that is included within the housing; an opening that extends through the housing in a first direction and fluidically communicates with the interior space; and a fluid detecting device that is positioned within the housing, is mounted adjacent to the opening, and detects a contact of a fluid. The fluid detecting device may include: a first member that includes a material or a circuit on a surface thereof, which reacts due to its contact with the fluid; and a second member that encloses a portion of the first member to hinder the fluid from coming into contact with the material or the circuit when the fluid flows in the first direction, but to allow the fluid to come into contact with the material or the circuit when the fluid flows in at least one direction, which is different from the first direction. The electronic device as described above may be variously implemented according to embodiments.

### CLAIM OF PRIORITY

This application claims priority under 35 U.S.C. §119(a) to Korean Application Serial No. 10-2015-0026690, which was filed in the Korean Intellectual Property Office on Feb. 25, 2015, the entire contents of which are hereby incorporated by reference.

### TECHNICAL FIELD

The present disclosure generally relates to an electronic device and, in particular, to an electronic device that is configured to determine a condition of the electronic device including, for example, whether the electronic device has been polluted or waterlogged.

### BACKGROUND

An electronic device refers to a device that conducts a specific function according to a program equipped therein, such as, for example, a digital organizer, a portable multimedia reproducer, a mobile communication terminal, a tablet PC, an image/sound device, a desktop/laptop computer, or a navigation system for a vehicle, including home appliances. The above-mentioned electronic devices may output stored information, for example, as a sound or an image. As the integration degree of the electronic devices have increased and ultrahigh speed and large capacity communication has been popularized, various functions have been recently equipped in a single mobile communication terminal. The electronic devices may perform a variety of function including in addition to a communication function. For example, the electronic devices may also perform such function as: an entertainment function (e.g., a game), a multimedia function (e.g., music/video image reproduction), a communication and security function for mobile banking, a schedule management function and an electronic wallet function.

As various functions have been integrated into a single electronic device, the electronic device may be used to assist in many daily activities. Such devices are convenient because they can be carried on ones person and enable many activities to be performed, as the single electronic device performs many and varied functions typically performed by standalone devices, such as a mobile communication terminal, provides a communication function, such as voice call or message, a digital organizer function, such as schedule management, a multimedia function, such as enjoying music/video images, and an office function that enables preparation of a memo or a document, a user may.

### SUMMARY

As using an electronic device while carrying the electronic device becomes the norm, the operating environment of the electronic device may be frequently changed. For example, the operating environment of the electronic device may be variously changed according to an indoor or outdoor environment or the weather at the time when the user engages in an activity. With respect to pollution or damage of the electronic device that is caused due to such environmental changes, determining a reason for the pollution or damage may enable the repair or the like of the polluted or damaged electronic device to be further facilitated. In order to determine whether the electronic device is simply polluted by moisture or whether the electronic device is waterlogged, for example, a fluid detecting device, which uses a material to be discolored by moisture, may be used.

As the size and weight of electronic devices are gradually reduced, arranging such a fluid detecting device may have difficulties. For example, in the case of an electronic device formed in a unibody structure, when such a fluid detecting device is arranged on the exterior of the electronic device, the external appearance of the electronic device may be degraded. In addition, when such a fluid detecting device is arranged within the electronic device, it may be difficult to observe the fluid detecting device unless the electronic device is disassembled. For example, since the electronic device formed in a unibody structure is difficult to disassemble not only by the user, but also by a repair/maintenance service provider, there may be difficulty in determining the reason for pollution or damage even if such a fluid detecting device is provided.

Therefore, various embodiments of the present disclosure provide an electronic device including a fluid detecting device that is useful for easily determining the reason for the pollution or damage of the electronic device.

In addition, various embodiments of the present disclosure provide an electronic device including a fluid detecting device that enables visual observation even if the electronic device is not disassembled.

Further, an electronic device may include a fluid detecting device that enables easy visual observation without affecting the external appearance of the electronic device even if the electronic device is formed in a unibody structure.

According to various embodiments of the present disclosure, an electronic device may include: a housing that forms an interior space therein; at least one electronic component that is included within the housing; an opening that penetrates the housing in a first direction and reaches the interior space; and a fluid detecting device that is positioned within the housing, is mounted adjacent to the opening, and detects the contact of a fluid.

The fluid detecting device may include: a first member that includes a material or a circuit on a surface thereof, which reacts due to its contact with the fluid; and a second member that encloses a portion of the first member to hinder the fluid from coming into contact with the material or the circuit when the fluid flows in the first direction while allowing the fluid to come into contact with the material or the circuit when the fluid flows in at least one direction, which is different from the first direction.

According to various embodiments, the electronic device allows the fluid detecting device to be visually observed from the outside of the housing while the fluid detecting device is provided within the housing. Therefore, the electronic device can be implemented to have an aesthetically pleasing exterior appearance even though the fluid detecting device is installed in the unibody structure. In addition, since it is possible to visually observe whether the electronic device is polluted or damaged through the fluid detecting device from the outside of the electronic device even if the electronic device is not disassembled, the fluid detecting device may be useful for the repair/maintenance of the electronic device. In addition, by setting a foreign matter infiltration route, or the like, using the shape of the second member, or the like, in configuring the fluid detecting device, the fluid detecting device may be used to determine the reason for the pollution or damage.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is an exploded perspective view illustrating an electronic device, according to one of various embodiments of the present disclosure;

FIG. 2 is a perspective view illustrating a portion of the electronic device, according to one of various embodiments of the present disclosure, in an enlarged scale;

FIG. 3 is an exploded perspective view for describing a fluid detecting device of the electronic device, according to one of various embodiments of the present disclosure;

FIG. 4 is an exploded perspective view illustrating a fluid detecting device of the electronic device, according to one of various embodiments of the present disclosure;

FIG. 5 is a partial cross-sectional view illustrating a configuration of the electronic device, according to one of various embodiments of the present disclosure;

FIG. 6, FIG. 7, FIG. 8, FIG. 9 and FIG. 10 are views illustrating various configurations of a fluid detecting device of an electronic device, according to one of various embodiments of the present disclosure, respectively;

FIG. 11 is a perspective view illustrating a portion of an electronic device, according to another one of various embodiments of the present disclosure, in an enlarged scale;

FIG. 12 is an exploded perspective view for describing a fluid detecting device of an electronic device, according to another one of various embodiments of the present disclosure;

FIG. 13 is a perspective view illustrating a fluid detecting device of an electronic device, according to another one of various embodiments of the present disclosure;

FIG. 14 is a view for describing a mounted state of the fluid detecting device of an electronic device, according to another one of various embodiments of the present disclosure;

FIG. 15 is a view illustrating the fluid detecting device of an electronic device, according to another one of various embodiments of the present disclosure, which is viewed from the outside of the housing of the electronic device;

FIG. 16 is a view for describing a state in which the fluid detecting device of the electronic device, according to another one of various embodiments of the present disclosure, is provided within the housing of the electronic device;

FIG. 17 is a sectional view taken along line A-A in FIG. 16; and

FIG. 18, FIG. 19, FIG. 20 and FIG. 21 are views illustrating various configurations of the fluid detecting device of the electronic device, according to another one of various embodiments of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements. In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” as used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

In the present disclosure, the terms are used to describe specific embodiments, and are not intended to limit the present disclosure. As used herein, the singular forms are intended to include the plural forms as well, unless the context clearly indicates otherwise. In the description, it should be understood that the terms “include” or “have” indicate existence of a feature, a number, a step, an operation, a structural element, parts, or a combination thereof, and do not previously exclude the existences or probability of addition of one or more another features, numeral, steps, operations, structural elements, parts, or combinations thereof.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present specification. In some cases, even the term defined in the present disclosure should not be interpreted to exclude embodiments of the present disclosure.

In the present disclosure, an electronic device may be a random device, and the electronic device may be called a terminal, a portable terminal, a mobile terminal, a communication terminal, a portable communication terminal, a portable mobile terminal, a display device or the like.

For example, the electronic device may be a smartphone, a portable phone, a game player, a TV, a display unit, a heads-up display unit for a vehicle, a notebook computer, a laptop computer, a tablet Personal Computer (PC), a Personal Media Player (PMP), a Personal Digital Assistants (PDA), and the like. The electronic device may be implemented as a portable communication terminal, which has a wireless communication function and is portable. Further, the electronic device may be a flexible device or a flexible display device.

The electronic device may communicate with an external electronic device, such as a server or the like, or perform an operation through an interworking with the external electronic device. For example, the electronic device may transmit an image photographed by a camera and/or position information detected by a sensor unit to the server through a network. The network may be a mobile or cellular communication network, a Local Area Network (LAN), a Wireless Local Area Network (WLAN), a Wide Area Network (WAN), Internet, a Small Area Network (SAN) or the like, but is not limited thereto.

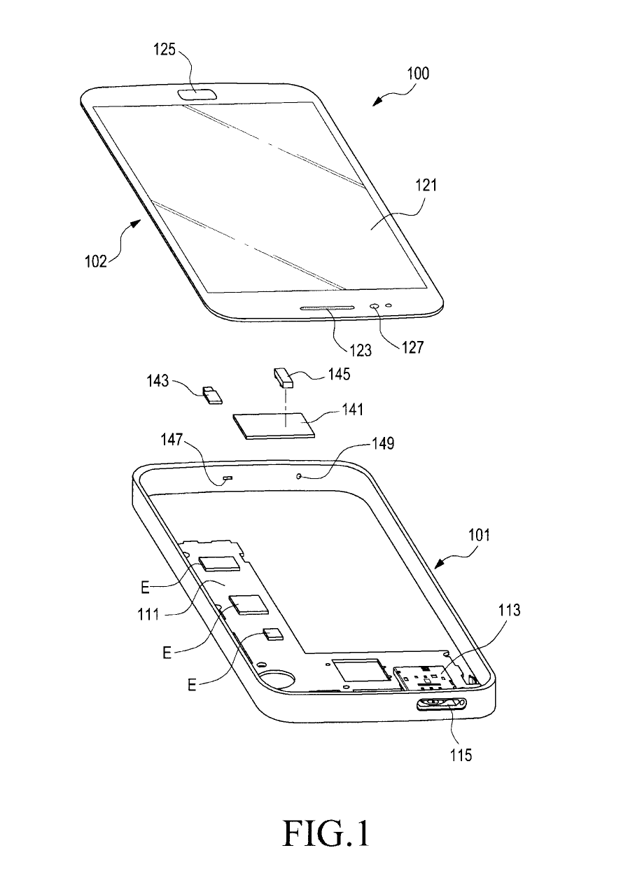

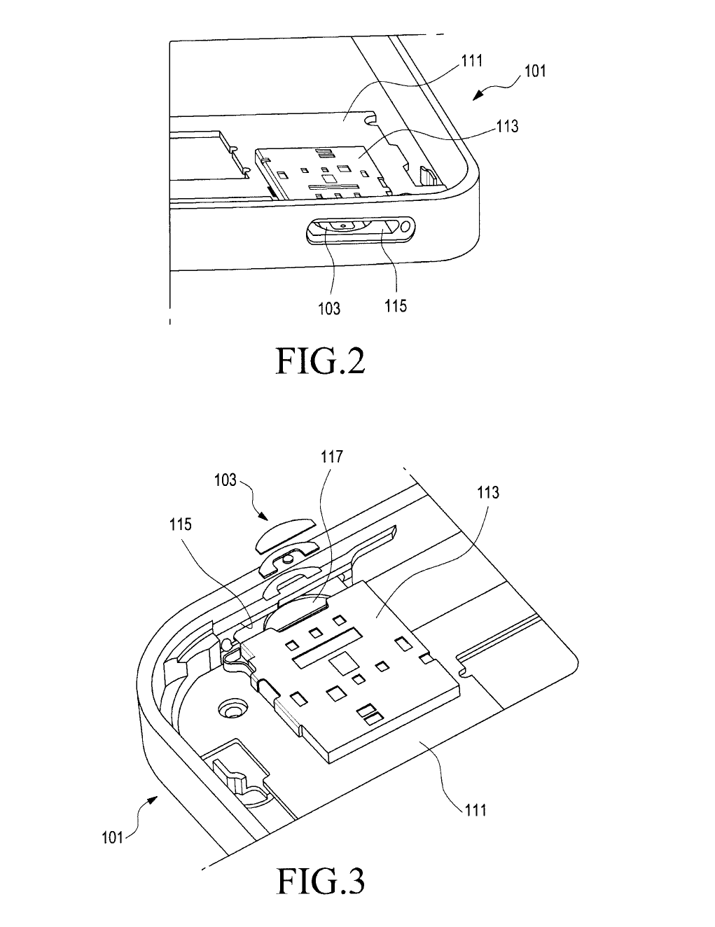

FIG. 1 is an exploded perspective view illustrating an electronic device 100, according to one of various embodiments of the present disclosure. FIG. 2 is a perspective view illustrating a portion of the electronic device 100, according to one of various embodiments of the present disclosure, in an enlarged scale.

Referring to FIGS. 1 and 2, according to one of various embodiments of the present disclosure, the electronic device 100 is formed in a unibody structure (e.g., a type formed to have a single housing 101 of which the front side is opened). A display device 102 may be mounted on or within the open front side of the housing 101.

The housing 101 may be provided with a circuit board 111, on which various circuit devices (e.g., electronic components E, such as an application processor, a communication module, and an internal memory), and various connection devices 113, 143, and 145 that provide means for connecting the electronic device 100 to another electronic device or an additional device. The connection devices 113, 143, and 145 may include, for example, a connector 143 to connect a charger or other electronic devices, a jack 145 to connect an ear phone or a microphone, and a socket in which a storage medium, a Subscriber Identification Module (SIM) card, or the like is mounted. The connection devices 113, 143, and 145 as described above may be mounted on the circuit board 111 or an auxiliary circuit board 141 provided separately from the circuit board 111. The arrangement of the connection devices 113, 143, and 145 may be properly adjusted in consideration of the positions of the other electronic components E arranged within the housing 101. The housing 101 may include openings 115, 147, and 149 so as to expose connection routes to the connection devices 113, 143, and 145. In the following detailed description, the connection devices may be denoted by reference “113” only.

The display device 102 may be configured by stacking display elements to output a screen, and a window member to transmit the screen therethrough while protecting the display elements. According to various embodiments, the display device 102 may include a touch panel to provide a touch screen function so that the display device 102 may also be used as, for example, an input device. The display device 102 may close the front side of the housing 101 so as to complete the exterior of the electronic device 100 so that most of the region of the front side of the housing 101 may be used as a screen display region 121. The display device 102 may include, around the periphery of the screen display region 121, a speaker hole 123 to output a sound, a transmission window 127 for various sensors (e.g., a proximity sensor or a illuminance sensor), and a keypad 125 to be operated in a mechanical or touch manner.

The housing 101 may form an internal space to accommodate the circuit board 111 or the like, as well as a fluid detecting device 103 to indicate pollution or damage of the electronic device 100 therein. The configuration of the fluid detecting device 103 will be described in more detail with reference to, for example, FIG. 3.

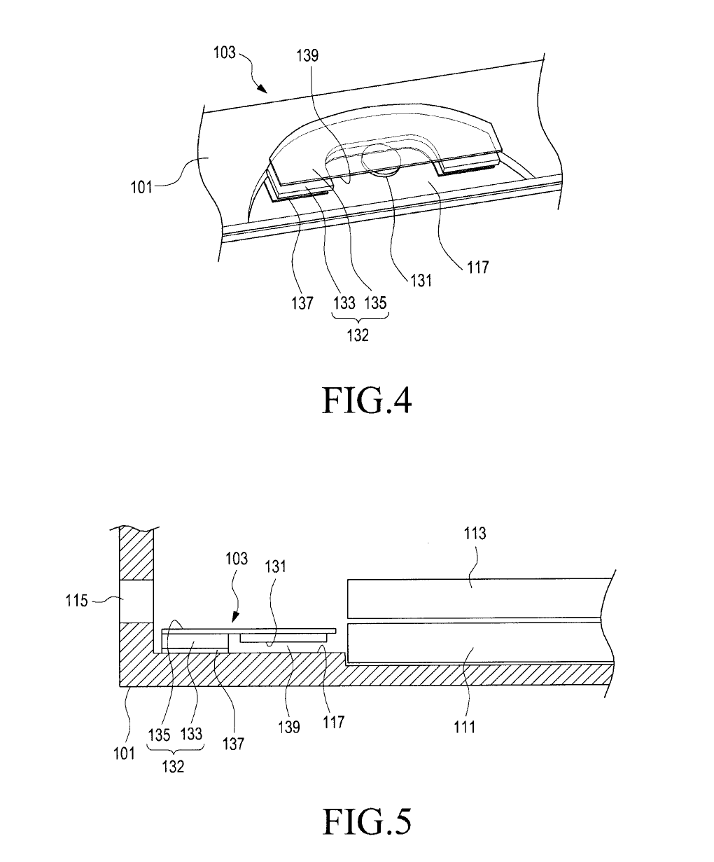

FIG. 3 is an exploded perspective for describing a fluid detecting device 103 of the electronic device 100, according to one of various embodiments of the present disclosure. FIG. 4 is an exploded perspective view illustrating the fluid detecting device 103 of the electronic device 100, according to one of various embodiments of the present disclosure. FIG. 5 is a partially cross-sectional view illustrating a configuration of the electronic device 100, according to one of various embodiments of the present disclosure.

In describing the construction of the fluid detecting device 103 illustrated in FIGS. 3 to 5, reference will be made to the above-described construction of the electronic device 100.

The fluid detecting device 103 may be positioned within the housing 101 adjacent to any one of the openings 115, 147, and 149 or each of two or more of the openings 115, 147, and 149 to be exposed to the outside. For example, the fluid detecting device 103 may be mounted on the inner wall of the housing 101 or on the inner wall of any of the openings 115, 147, and 149 to be visually identified from the outside of the housing 101. A mounting recess 117 may be formed on the inner wall of the housing 101 (or the inner wall of the opening 115) for mounting the fluid detecting device 103 within the housing 101. The depth of the mounting recess 117 may be formed to correspond to the thickness of the fluid detecting device 103. In a specific embodiment of the present disclosure, the fluid detecting device 103 may be positioned adjacent to the connection device 113 (e.g., a socket for a storage medium or the like). The fluid detecting device 103 may be degenerated by foreign matter that flows into the housing 101 from the outside so as to allow a user or a service provider to recognize pollution, damage, or the like inside the electronic device 100. The foreign matter may flow into the housing 101 not only through the openings corresponding to the above-described connection devices, but also through openings for the input/output of a sound at the time of a voice call (e.g., the above-mentioned speaker hole 123), a sound output hole provided separately from the above-mentioned speaker hole 123, a coupling boundary portion between various outwardly exposed components, or the like. The fluid detecting device 103 may be positioned in consideration of such foreign matter inflow routes.

The fluid detecting device 103 may include a first member 131 and a second member 132. The second member 132 may include a first guide member 133 attached to the housing 101, and a second guide member 135 attached to the first guide member 133.

The first member 131 may be degenerated by foreign matter that has flowed into the housing 101 from the outside (e.g., a fluid, such as moisture or water). For example, the first member 131 may include a material that reacts due to its contact with the fluid (e.g., a paper, a non-woven cloth, or a fabric that is printed or coated with a water-soluble dye) and may be decolored by the fluid (e.g., moisture or water). According to various embodiments, the first member 131 may include, on its surface, a circuit that reacts due to its contact with a fluid. The circuit, which is included in the first member 131 and reacts due to its contact with the fluid, may be electrically connected with one of the electronic components E that is accommodated within the housing 101 (e.g., an application processor).

According to various embodiments, in the case where the first member 131 includes a material that reacts due to its contact with a fluid, the first member 131 may be coated with a water-soluble fixing liquid (e.g., alumina liquid, acryl liquid, or urethane liquid). As a result, the first member 131 may be degenerated (e.g., decolored) when moisture or water infiltrates into the electronic device 100. The degree by which the first member 131 is degenerated may correspond to the degree by which a malfunction of the electronic device would occur such that minor infiltrations may cause minimal or no degeneration of the first member 131.

The second member 132 may accommodate the first member 131, and may provide a route that allows the foreign matter (e.g., moisture or water) infiltrating into the house 101, to reach the space that accommodates the first member 131, in a predetermined direction. For example, it is possible to limit the route that allows the foreign matter infiltrating into the housing 101 from the outside, to reach the first member 131 within the housing 101.

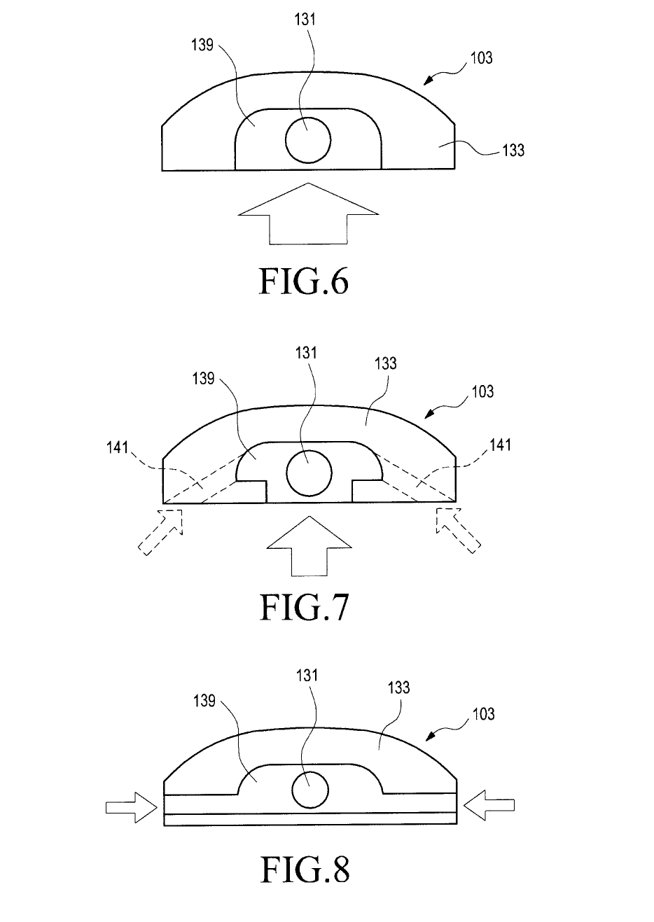

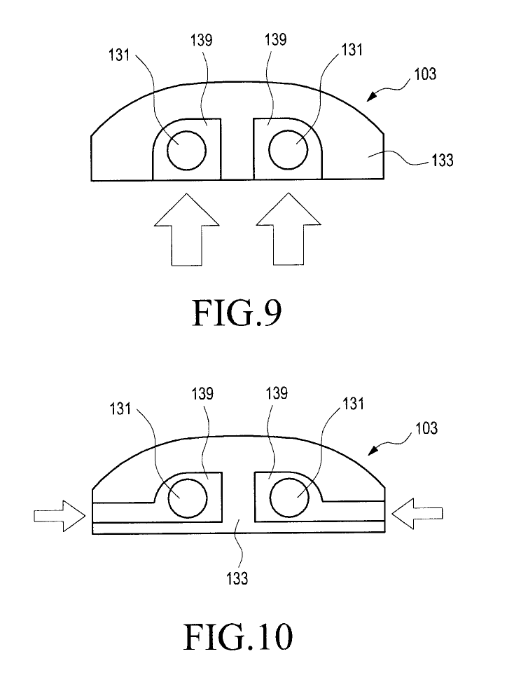

The first guide member 133 may be manufactured by processing a film, which is formed of a synthetic resin (e.g., a polycarbonate material) and may have a thickness of scores to hundreds of micrometers (μm). The first guide member 133 may have a “C” shape. However, the present disclosure is not necessarily limited thereto, and the shape or the like of the first guide member 133 will be described in more detail with reference to, for example, FIG. 6. The first guide member 133 may be arranged to partially enclose the circumference of the first member 131. For example, the first guide member 133 may provide an accommodation portion 139 that accommodates the first member 131. The first guide member 133 may be attached such that one surface thereof faces the inner wall of the housing 101 (e.g., the recess 117 of the mounting recess).

An adhesive or a double-sided tape 137 may attach the guide member 133 to the mounting recess 117. According to various embodiments, for the first guide member 133, a portion of the second member may be formed by the housing 101 itself by processing the inner wall of the housing 101. For example, a portion of the second member 132 may be formed by processing the inner wall of the housing 101 (e.g., the mounting recess 117) to correspond to the shape of the first guide member 133.

The second guide member 135 may be attached to the other surface of the first guide member 133. For example, the accommodation portion 139 may be closed by the second guide member 135 on the other surface of the first guide member 133. The first member 131 may be disposed between the inner wall of the housing 101 (e.g., the bottom surface of the mounting recess 117) and the second guide member 135 by being attached to the second guide member 135 and accommodated into the accommodation portion 139. The second guide member 135 may include a single-sided tape. When the second guide member 135 includes a single-sided tape, after the second guide member 135 is attached to the first guide member 133, the tape may facilitate attaching the first member 131 thereto. Opposite surfaces of the first member 131 may be enclosed by the inner wall of the housing 101 and the second guide member 135, respectively, and most of the circumference thereof may be enclosed by the first guide member 133. A portion of the accommodation portion 139 may be communicated with the outside of the first guide member 133 so as to allow the foreign matter, which infiltrates into the housing 101 from the outside, to flow into the accommodation portion 139. In addition, the second guide member 135 may be made of a transparent material so that the first member 131 may be easily visually identified even at the outside of the housing 101 through the opening 115.

According to the arrangement and shape of the second member 132 as described above, a route, which allows foreign matter (e.g., a fluid, such as moisture or water) to infiltrate into the housing 101 from the outside to the first member 131, may be limited thereto so that the foreign matter is inhibited from entering areas outside of the route. The fluid detecting device 103 may be arranged adjacent to the upper end of the housing of the electronic device 100. For example, the connection device 113 for a storage medium or the like is arranged in the upper end portion within the housing 101, and the fluid detecting device 103 may be arranged on the inner wall of the housing 101 (or the inner wall of the opening 115) between the connection device 113 and the outer surface (e.g., the upper end surface) of the housing 101. Accordingly, the fluid detecting device 103 may be visually exposed to the outside through an opening (e.g., the opening 115 formed in the upper end surface of the housing 101) formed to correspond to the connection device 113.

The above-mentioned fluid detecting device 103 (e.g., the second member) may limit the route that allows the foreign matter to infiltrate into the first member 131. For example, referring to FIG. 5, the foreign matter infiltrating from the opening 115 to a position where the first member 131 is positioned, is blocked by the first guide member 133 or the second guide member 135 so that the foreign matter may not or is inhibited from reaching the first member 131. For example, even if a small amount of water infiltrates through the opening 115 while the user performs a voice call, the water may not reach the first member 131 by being blocked by the first guide member 133 and the second guide member 135, and the first member 131 may not be degenerated. Whereas, when the amount of water, which infiltrates through the opening 115 or other various routes (e.g., the above-mentioned speaker hole 123 or the like), increases (e.g., by being waterlogged), for example, when water is collected in a space, for example, between the fluid detecting device 103 and the circuit board 111, the water may infiltrate into the accommodation portion 139. For example, when the water infiltrates into the electronic device 100 over a predetermined amount, the degeneration of the first member 131 may be caused, and based on this, a user or a service provider may foresee or sense the pollution of the electronic device 100 or the damage caused thereby.

The above-described embodiments have exemplified a configuration in which the fluid detecting device 103 is arranged adjacent to a socket for a storage medium or openings 147 and 149. However, the fluid detecting device 103 may be arranged to correspond to the other types of connection devices described above, such as, for example, the connector 143 and the jack 145). In addition, while a specific embodiment of the present disclosure has exemplified a configuration in which one fluid detecting device 103 is disposed within the housing 101, a plurality of fluid detecting devices may be arranged at different positions such as, for example adjacent to the speaker hole 123 or the like.

FIGS. 6 to 10 are views illustrating various configurations of the fluid detecting device 103 of the electronic device, according to one of various embodiments of the present disclosure, respectively.

The fluid detecting device 103 may variously set the foreign infiltration routes according to the configuration (e.g., shape) of, for example, the first guide member 133. In the following description made with reference to FIGS. 6 to 10, descriptions will be made with reference to a configuration in which the opening 115 of the housing 101 reaches the interior space of the housing 101 from the upper side of the fluid detecting device 103 through the housing 101 along a first direction as illustrated in FIGS. 6 to 10, by way of an example.

The fluid detecting device 103 illustrated in FIGS. 6 and 7 is exemplified to have a configuration that is the same as or similar to the above-mentioned fluid detecting device. In the fluid detecting device 103, a foreign matter infiltration route may be formed in a direction parallel to and opposite to the opening 115, for example, in a reverse direction to the first direction. For example, the accommodation portion 139 may communicate with the outside of the first guide member 133 to the lower side of the fluid detecting device 103. Here, the description, “parallel to the opening 115,” may mean that the foreign matter infiltration route is parallel to the direction where the opening 115 and the fluid detecting device 103 are arranged.

According to various embodiments, as illustrated in FIG. 7, the fluid detecting device 103 may further include an infiltration route 141 that is formed in a direction inclined to the opening 115 (which is shown in FIG. 5). The infiltration route 141 formed in the direction inclined to the opening 115 may extend to be spaced away from the opening 115 in a direction away from the first member 131. In the fluid detecting device 103, the foreign matter, which may infiltrate in a direction perpendicular to the opening 115 or toward the first member 131 from the opening 115, may be blocked. For example, the first guide member 133 may block foreign matter, which may infiltrate in the direction perpendicular to the opening 115 or toward the first member 131 from the opening 115. In addition, the foreign matter, which infiltrates in the inclined direction from a point adjacent to the opening 115 toward the first member 131, may also be blocked by the first guide member 133.

The foreign matter infiltration routes of the fluid detecting device 103, which are illustrated in FIGS. 6 and 7, respectively, may be implemented to have different widths. Even if the first members 131 are made of the same dye and in the same size, the amounts of water, which are required for degenerating the first members 131, respectively, may be different from each other. For example, in the case where the fluid detecting device with a narrower foreign matter infiltration route (e.g., the fluid detecting device illustrated in FIG. 7) is installed in the electronic device 100, the first member 131 may be degenerated only when a larger amount of foreign matter than that of the foreign matter, which infiltrates into the fluid detecting device illustrated in FIG. 6, infiltrates into the inside of the housing 101. For example, the fluid detecting device 103 illustrated in FIG. 6 may be decolored even in a case where the electronic device is partially exposed to highly humid weather or rainy weather. In the case where the electronic device is completely submerged under water (waterlogged), the fluid detecting device illustrated in FIG. 7 may be degenerated in a state where the electronic device. When both the fluid detecting devices 103 illustrated in FIGS. 6 and 7 are provided in the electronic device 100, it is possible to determine whether the pollution or damage of the electronic device 100 is caused by simple moisture or water infiltration or whether the pollution or damage of the electronic device 100 is caused by waterlogging. For example, when only the fluid detecting device illustrated in FIG. 6 was decolored in the electronic device in which both the fluid detecting devices 103 illustrated in FIGS. 6 and 7 are provided, it can be determined that the pollution was caused by simple moisture or water infiltration. On the other hand, when the fluid detecting device illustrated in FIG. 7 was also decolored, it can be determined that the electronic device 100, in which both the fluid detecting devices 103 are provided, was completely submerged under water.

Referring to FIG. 8, the accommodation portion 139 may communicate with the outside of the first guide member 133 in a direction that is orthogonal to the opening 115 (e.g., a second direction substantially orthogonal to the first direction). For example, the fluid detecting device 103 illustrated in FIG. 8 may provide a foreign matter infiltration route along a direction perpendicular to the opening 115 may block foreign matter, which infiltrates in a direction parallel to or inclined to the opening 115.

Referring to FIGS. 9 and 10, according to various embodiments, the fluid detecting device 103 may include a plurality of first members 131.

A first guide member 133 of the fluid detecting devices 103 may provide a plurality of accommodation portions 139 that are spaced apart from each other. The first members 131 may be arranged in the accommodation portions 139, respectively, and the accommodation portions 139 may provide foreign matter infiltration routes that are independent from each other. For example, the plurality of accommodation portions 139 and first members 131 may be arranged symmetrical to each other on the first member 101. Similar to the embodiments described above, the fluid detecting device 103 may limit the routes that allow fluid or other matter, which has infiltrated from the outside, to reach the first members 131. For example, depending on the directions where the accommodation portions 139 are communicated with the outside of the first guide member 133, the fluid detecting device 103 may guide the foreign matter infiltration route to a direction that is parallel to or perpendicular to the opening 115.

FIGS. 9 and 10 exemplify a configuration in which the first members 131 or the like are symmetrically arranged. According to various embodiments, the plurality of accommodation portions 139 may have asymmetric shapes in relation to each other on the first guide member 133. For example, the left accommodation portion may have a foreign matter infiltration route that is formed to be smaller than that of the right accommodation portion. Accordingly, in the case of the accommodation portions 139 having asymmetric shapes in relation to each other, the degree of pollution of the electronic device 100 (e.g., whether the electronic device 100 suffered from moisture or water infiltration or waterlogging) may be determined depending on whether the first members 131 are degenerated. In addition, in the case where the accommodation portions 139 have symmetric shapes, it may be possible to determine from which direction the electronic device 100 suffered from waterlogging and how much the electronic device 100 suffered from the waterlogging when it is observed that any one of the first members 131 is discolored.

As described above, when a plurality of first members 131 are arranged in one fluid detecting device 103, the pollution process, the pollution degree, or the like of the electronic device 100 may be determined according to the positions of the first members 131 or the shapes of the accommodation portions 139 (e.g., the direction communicated to the outside of the first guide member 133). For example, when the electronic device including the fluid detecting device 103 illustrated in FIG. 10 suffers from the moisture or water infiltration from the left side, only the left first member may be decolored. In addition, even if all the first members 131 are degenerated, the first member, which was first subjected to the moisture infiltration or the water infiltration, is more degenerated so that the water infiltration direction, the pollution degree, or the like of the electronic device may be foreseen.

In describing various embodiments of the present disclosure, although the routes, which allow foreign matter to infiltrate into the accommodation portion 139, have been described with reference to a configuration in which the route is formed in the reverse direction to the first direction (e.g., the embodiments illustrated in FIGS. 6, 7, and 9) and a configuration in which the route is formed in a direction substantially perpendicular to the first direction (e.g., the embodiments illustrated in FIGS. 8 and 10), respectively, by way of examples, the present disclosure is not necessarily limited thereto. For example, the routes, which allow the foreign matter to infiltrate into the accommodation portion 139, may have a configuration in which the route is formed in the reverse direction to the first direction and in which the route is formed in the direction substantially perpendicular to the first direction.

Like this, according to the various embodiments of the present disclosure, since the electronic device 100 includes the fluid detecting devices 103 that may be observed from the outside (the outside of the housing 100) even if the electronic device 100 is not disassembled, the pollution or damage of the electronic device 100 may be easily identified. In addition, according to various embodiments of the present disclosure, the fluid detecting devices 103 of the electronic device 100 may be arranged inside the previously provided openings 115, 147, and 149 (e.g., openings formed to correspond to connection devices) to be easily visually identified while suppressing the degradation of the external appearance of the electronic device 100.

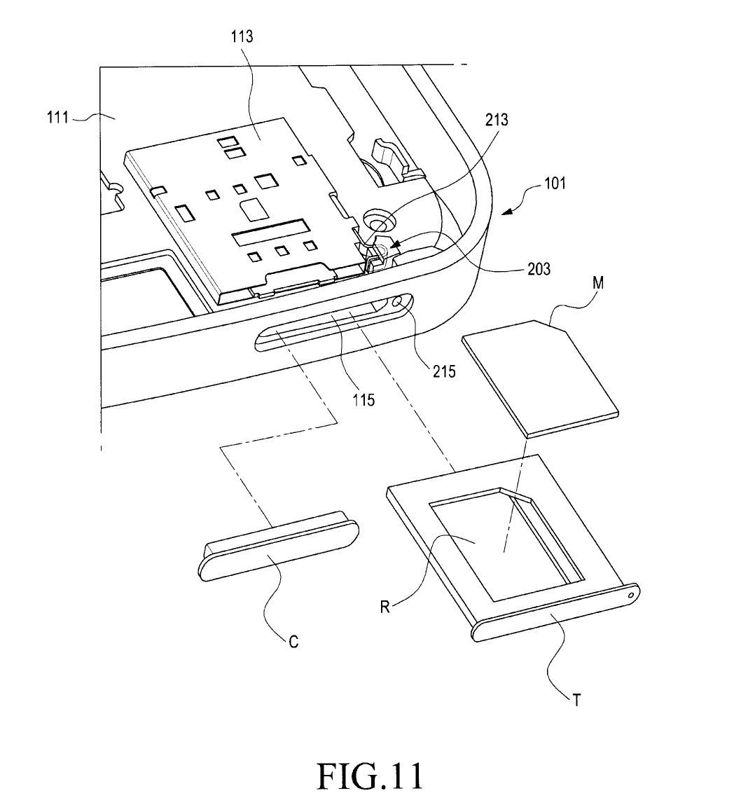

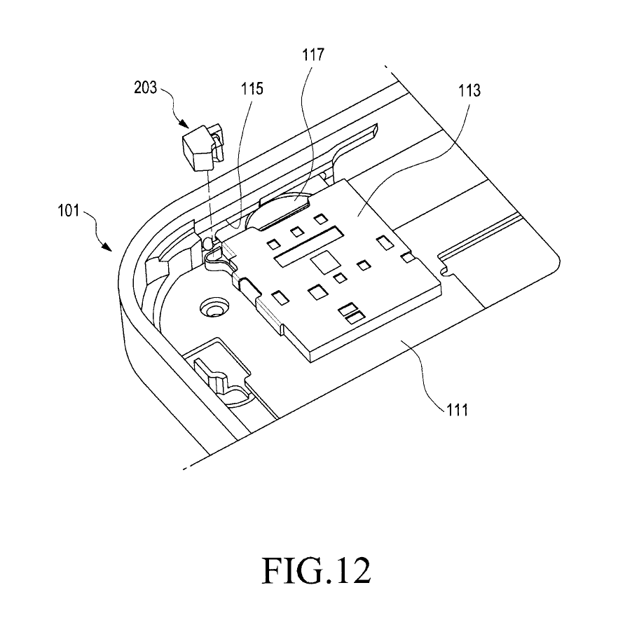

FIG. 11 is a perspective view illustrating a portion of an electronic device, according to another one of various embodiments of the present disclosure, in an enlarged scale. FIG. 12 is an exploded perspective view for describing a fluid detecting device 203 of an electronic device, according to another one of various embodiments of the present disclosure.

The electronic device according to the present embodiment is different from the preceding embodiments in a configuration in which a fluid detecting device 203 is installed. Thus, it is noted that the components that can be easily understood through the preceding embodiments will be denoted by the same reference numerals or omitted and the detailed descriptions thereof may also be omitted. In addition, although not illustrated in FIG. 11 or the like, the components and reference numerals thereof of the electronic devices described in the preceding embodiments may be cited in the detailed description of the present embodiment.

Referring to FIGS. 11 and 12, according to another one of various embodiments of the present disclosure, the fluid detecting device 203 of the electronic device 100 may be installed on a connection device 113. For example, the second member, to which the first member 131 is attached, may be bonded and fixed to the connection device 113. The housing 101 may further include a second opening 215 that may expose the fluid detecting device 203 to the outside, i.e., to the exterior of the housing 101. The second opening 215 may be arranged adjacent to the opening 115 formed to correspond to the connection device 113. The connection device 113 may further include a fixing member 213 (e.g., a hook) to fix the fluid detecting device 203.

In general, the electronic devices may include separate components that are configured to be attachable to/detachable from the electronic devices through the above-described openings, for example, cover members. Among the cover members, a cover C to normally close the opening 115 may be included. The cover C may be directly engaged with the opening 115, and the user may separate the cover C from the opening 115 as needed. In addition, components that may be attached to or detached from the electronic devices (e.g., the cover members) may include a tray T that is mounted in the opening 115 to be at least partially inserted into the opening, and further, into, for example, the connection device 113. The tray T may be mounted in the connection device 113 in a push-pull manner. The tray T as described above may include a recess R formed on one surface thereof. In the recess R, an external storage medium (e.g., a package including an integrated circuit) may be accommodated.

The connection device of the tray structure may facilitate the insertion and extraction of the storage medium while minimizing the exposure to the outside. The connection device of the tray structure may be provided with a lever or a link, or a hole to operate the lever or the link for the extraction operation, and the second opening 215 may be used as such a hole.

The connection device 113 may be arranged adjacent to the opening 115, and the housing 101 may further include the second opening 215 that is formed parallel to the opening 115. As described above, the second opening 215 may be used as a hole for providing the binding means or for operating the lever or the like. The connection device 113 may include, for example, a hook as a fixing member 213 for mounting the fluid detecting device 203. The fixing member 213 extends at a side of the connection device 113, and may have a “U” shape in the portion where it is bonded to the fluid detecting device 203. Meanwhile, in the case where the connection device 113 is manufactured in the tray structure, the fixing member 213 may be used as a lever to extract the storage medium mounted in the connection device 113. For example, the fixing member 213 may be disposed adjacent to the second opening 215. The fluid detecting device 203 may be fixed to the connection device 113 through the fixing member 213 to face the second opening 215 or may be positioned in close contact with the inner wall of the housing 101 around the second opening 215.

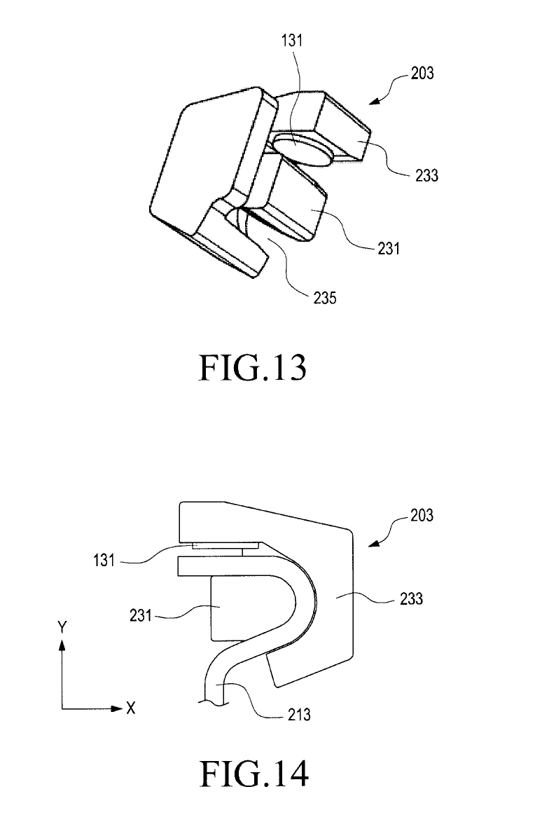

FIG. 13 is a perspective view illustrating a fluid detecting device 203 of an electronic device, according to another one of various embodiments of the present disclosure.

Referring to FIG. 13, the fluid detecting device 203 may include a second member and a first member 131 that is attached to the inner surface of the second member (e.g., the inner surface of a mounting portion to be described later).

The second member may include a protrusion 231 and a mounting portion 233 formed around the protrusion 231. The mounting portion 233 may be formed to at least partially enclose the outer peripheral surface of the protrusion 231 with a gap being interposed therebetween. The protrusion 231 may be at least partially enclosed by the fixing member 213. For example, the gap between the protrusion 231 and the mounting portion 233 may form a binding recess 235 so that a portion of the connection device 113 (e.g., a portion of the fixing member 213) may be engaged in the binding recess 235. The first member 131 may be attached to the inner wall of the binding recess 235 (e.g., the inner surface of the mounting portion 233). The second member may be made of a transparent material (e.g., a synthetic resin, such as polycarbonate or acryl). Accordingly, even if the first member 131 is attached to the inner surface of the mounting portion 233, a user or a service provider may observe whether the first member 131 is decolored from the outside of the fluid detecting device 203.

A structure for installing the fluid detecting device 203 will be described with reference to FIGS. 14 to 17.

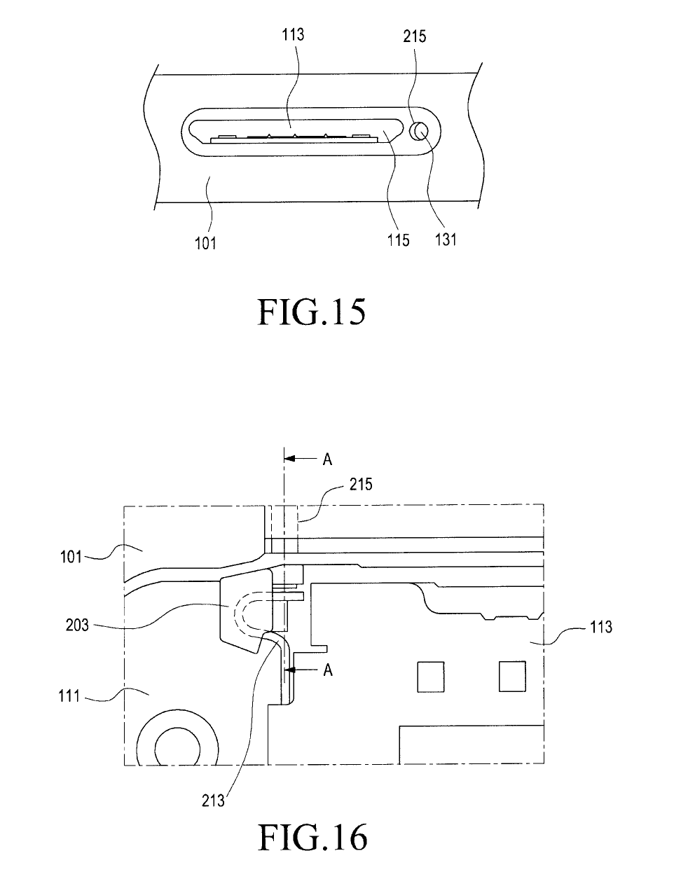

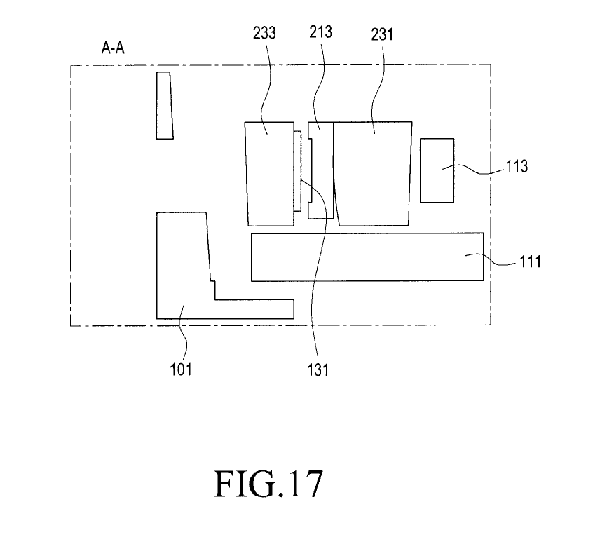

FIG. 14 is a view for describing a mounted state of a fluid detecting device 203 of an electronic device, according to another one of various embodiments of the present disclosure. FIG. 15 is a view illustrating the fluid detecting device 203 of an electronic device, according to another one of various embodiments of the present disclosure, which is viewed from the outside of the housing 101 of the electronic device. FIG. 16 is a view for describing a state in which the fluid detecting device 203 of an electronic device, according to another one of various embodiments of the present disclosure, is arranged within the housing 101 of the electronic device. FIG. 17 is a sectional view taken along line A-A in FIG. 16

As illustrated in FIGS. 14 to 17, the fluid detecting device 203 may be mounted on and fixed to the connection device 113 (e.g., the fixing member 213). As described above, the fixing member 213 may be used as a lever for extracting a storage medium or the like from the connection device of the tray structure, and may be arranged adjacent to the second opening 215. For example, the connection device 113 may be arranged adjacent to the opening 115, and the fixing member 213 may be arranged adjacent to the second opening 215. The fluid detecting device 203 may be mounted on the fixing member 213 to visually expose the first member 131 through the second opening 215. However, when a cover member (not illustrated) is mounted on the opening 115, the opening 115 and the second opening 215 may be closed and the first member 131 may also be concealed.

In fixing and mounting the fluid detecting device 203 on the fixing member 213, the fixing member 213 may be arranged such that it enclosing at least a portion of the protrusion 231. The mounting portion 233 may be arranged to enclose at least a portion of the fixing member 213. The fixing member 213 may be configured in a “U” shape, and the binding recess 235 may have corresponding shape to that of the fixing member 213. In addition, by coupling the fixing member 213 to the binding recess 235, the movement of the fluid detecting device 203 in relation to the fixing member 213 may be restricted. For example, the movement of the fluid detecting device 203 in a horizontal direction (X) or in a vertical direction (Y) in relation to the fixing member 213 may be restricted. Accordingly, the fluid detecting device 203 may be maintained in the state where the fluid detecting device 203 is aligned with the second opening 215, and the first member 131 may also be exposed to the outside of the housing 101 through the second opening 215.

The second member may guide or restrict an infiltration route of foreign matter to the first member 131. For example, the foreign matter infiltrating through the second opening 215 is blocked by the second member so that the foreign matter cannot reach the first member 131. Referring to FIG. 14, foreign matter may infiltrate toward the first member 131 from the left side of the second member in the horizontal direction (X), and the foreign matter infiltrating from the right side is blocked by the second member so that the foreign matter cannot reach the first member 131.

As described above with reference to the embodiments, the route that allows foreign matter to reach the first member 131 described above is not limited to the exemplary embodiments and may be variously changed depending on the configuration (shape) of the second member. For example, in the structure illustrated in FIG. 16, it will be appreciated that a route, which allows the foreign matter to infiltrate into the first member 131, may be formed in the case where foreign matter infiltrates through an opening (e.g., the above-described opening 115) formed to correspond to the connection device 113. However, the route, which allows the foreign matter to infiltrate into the first member 131, may be blocked by the opening, which is formed to correspond to the connection device 113 depending on the shape of the second member.

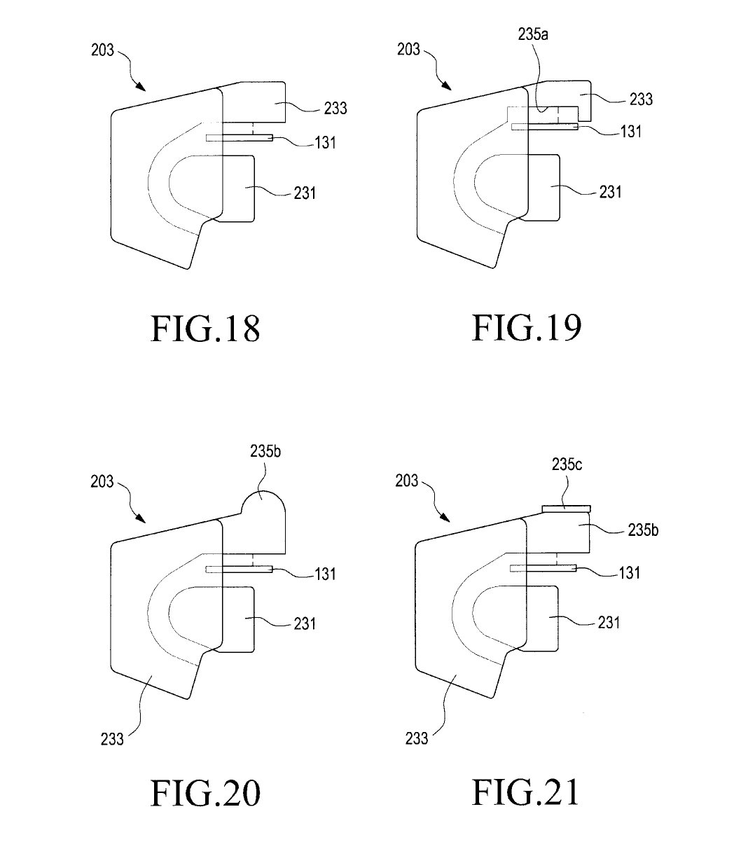

FIGS. 18 to 21 are views illustrating various configurations of the fluid detecting device 203 of the electronic device, according to another one of various embodiments of the present disclosure.

As illustrated in FIGS. 18 to 21, the fluid detecting device 203, for example, the second member may be variously changed.

For example, as illustrated in FIG. 19, the second member may further include an accommodation recess 235a to which the first member 131 is attached. The first member 131 may not protrude above the binding recess 235a by being accommodated in the accommodation recess 235a. For example, it is possible to prevent the fixing member 213 from being interfered with the first member 131 in the process of mounting the fluid detecting device 203 on the fixing member 213.

Referring to FIGS. 20 and 21, the fluid detecting device 203 may further include an optical member arranged to correspond to the first member 131 (e.g., a convex lens 235b or a polarizing plate 235c). The optical members 235b and 235c may be arranged integrally on the outer surface of the mounting portion 233 or may be separately assembled to the outer surface of the mounting portion 233. In a practical electronic device, when the opening (e.g., the second opening 215) aligned to the first member 131 is formed to be considerably small, it is possible to more easily identify whether the first member 131 is discolored by providing the above-mentioned optical members 235b and 235c.

The exemplary embodiments described herein are not intended to be limiting by are merely by way of illustration as other embodiments will be apparent to those of ordinary skill in the art that remain within the scope and spirit of the present disclosure. For example, although the specific embodiments of the present disclosure have exemplified the configuration of the second member in which the accommodation recess 235a or each of the optical members 235b and 235c is formed, the present disclosure is not limited thereto. Also for example, the second member having the accommodation recess 235a formed therein may also include the optical member, such as the convex lens 235b or the polarizing plate 235c.

As described above, according to various embodiments of the present disclosure, an electronic device may include: a housing that forms an interior space therein; at least one electronic component that is included within the housing; an opening that extends through an exterior surface of the housing in a first direction and fluidically communicates with the interior space; and a fluid detecting device that is positioned within the housing, is mounted adjacent to the opening, and is configured to detect a contact of a fluid.

The fluid detecting device may include: a first member that includes fluid detecting part that may include a material or a circuit on a surface thereof, which is configured to react due to contact with the fluid; and a second member that encloses a portion of the first member to hinder the fluid from coming into contact with the material or the circuit when the fluid flows in the first direction, but to allow the fluid to come into contact with the material or the circuit when the fluid flows in at least one direction, which is different from the first direction.

According to various embodiments, the at least one direction, which is different from the first direction, may include a second direction that is a reverse direction to the first direction.

According to various embodiments, the at least one direction, which is different from the first direction, may further include a third direction that is substantially orthogonal to the first direction.

According to various embodiments, the at least one direction, which is different from the first direction may include a second direction, which is substantially orthogonal to the first direction.

According to various embodiments, the material, which reacts due to its contact with the fluid, may be discolored when the material comes into contact with the fluid, and is arranged to be visually observed from an outside of the housing through the opening.

According to various embodiments, the first member may include a translucent or transparent material, and is configured such that the material, which reacts due to its contact with the fluid, is visually observed from the outside of the housing through the opening.

According to various embodiments, the circuit, which reacts due to its contact with the fluid, may be electrically connected with a processor that is included in the housing.

According to various embodiments, the electronic device may further include a component that covers the opening or is mounted within the opening, the component being detachably coupled to or attachable to/detachable from the electronic device.

According to various embodiments, the component may include a tray in which a recess is formed to accommodate a cover that covers the opening or is mounted within the opening and/or a package that includes an integrated circuit.

According to various embodiments, the electronic device may further include a connection device that is arranged to correspond to the opening within the housing. The fluid detecting device may be arranged on an inner wall of the housing between the connection device and an outer surface of the housing.

According to various embodiments, the second member may be attached to the inner wall of the housing by a double-sided tape.

According to various embodiments, the second member may include: a first guide member, on surface of which is attached to an inner wall of the housing; and at least one accommodation portion that is formed in the first guide member to accommodate the first member. The accommodation portion may be partially communicated to an outside of the first guide member in order to allow foreign matter, which may have infiltrated into the housing from the outside (i.e., from the exterior of the housing), to infiltrate into the accommodation portion.

According to various embodiments, the second member may further include a second guide member that is attached to another surface of the first guide member, and the first member may be accommodated in the accommodation portion between the inner wall of the housing and the second guide member.

According to various embodiments, the second guide member may be formed of a transparent single-sided adhesive tape, and the first member may be accommodated in the accommodation portion in a state where it is attached to the second guide member.

According to various embodiments, the electronic device may further include: a second opening that is formed in the housing and is positioned parallel to the opening; and a connection device that is arranged within the housing to correspond to the second opening. The second member may be mounted on the connection device.

According to various embodiments, the second member may include: a protrusion; a mounting portion that is formed around the protrusion; and a binding recess that is formed between the protrusion and the mounting portion. A portion of the connection device may be engaged with the binding recess.

According to various embodiments, the second member may be made of a transparent material and arranged adjacent to the opening.

According to various embodiments, the first member may be attached to an inner surface of the mounting portion to be visually exposed to the outside of the housing through the opening.

According to various embodiments, the electronic device may further include an optical member that is attached to an outer surface of the mounting portion and arranged to correspond to the first member.

According to various embodiments, the second member may further include an accommodation recess that is formed on an inner surface of the mounting portion, and the first member may be attached to the accommodation recess.

While the present disclosure has been shown and described with reference to certain embodiments thereof, it will be understood by those skilled in the art that various changes in form and details may be made therein without departing from the spirit and scope of the present disclosure as defined by the appended claims.

What is claimed is:

1. An electronic device comprising:
a housing having an interior space within the housing;
at least one electronic component that is disposed within the housing;
an opening that extends through an exterior surface of the housing in a first direction fluidically communicates with the interior space of the housing; and
a fluid detecting device that is positioned within the housing, is mounted adjacent to the opening, and is configured to detect a fluid, wherein the fluid detecting device includes:
a first member that includes a fluid reacting part including at least one of a material and a circuit on a surface thereof, which is configured to react to contact with the fluid; and
a second member that encloses a portion of the first member to hinder the fluid from coming into contact with the fluid reacting part when the fluid flows in the first direction, the second member allowing the fluid to come into contact with the fluid reacting part when the fluid flows in at least one direction, which is different from the first direction.

2. The electronic device of claim 1, wherein the at least one direction is different from the first direction and includes a second direction that is opposite to the first direction.

3. The electronic device of claim 2, wherein the at least one direction further includes a third direction that is substantially orthogonal to the first direction.

4. The electronic device of claim 1, wherein the at least one direction is different from the first direction and includes a second direction that is substantially orthogonal to the first direction.

5. The electronic device of claim 1, wherein the material of the fluid reacting part is discolored when the material comes into contact with the fluid and is arranged to be visually observed from an exterior of the housing through the opening.

6. The electronic device of claim 5, wherein the first member includes a translucent or transparent material, and is configured such that the material of the fluid reacting part is visually observed from the outside of the housing through the opening.

7. The electronic device of claim 1, wherein the circuit of the fluid reacting part is electrically connected to a processor that is included in the housing.

8. The electronic device of claim 1, further comprising:
a component that covers the opening or is mounted within the opening, the component being detachably coupled to the electronic device.

9. The electronic device of claim 8, wherein the component includes at least one of a tray in which a recess is formed to accommodate a cover that covers the opening or is mounted within the opening and a package that includes an integrated circuit.

10. The electronic device of claim 1, further comprising:
a connection device that is arranged to correspond to the opening within the housing, wherein the fluid detecting device is arranged on an inner wall of the housing between the connection device and an outer surface of the housing.

11. The electronic device of claim 10, wherein the second member is attached to the inner wall of the housing by a double-sided tape.

12. The electronic device of claim 1, wherein the second member includes:
a first guide member including a first surface that is attached to an inner wall of the housing; and
at least one accommodation portion that is formed in the first guide member to accommodate the first member, and
wherein the accommodation portion is partially communicated to an outside of the first guide member to allow foreign matter, which has infiltrated into the housing from the outside, to infiltrate into the accommodation portion.

13. The electronic device of claim 12, wherein the second member further includes a second guide member that is attached to a second surface of the first guide member, and
wherein the first member is accommodated in the accommodation portion between the inner wall of the housing and the second guide member.

14. The electronic device of claim 13, wherein the second guide member is formed of a transparent single-sided adhesive tape, and the first member is accommodated in the accommodation portion in a state where it is attached to the second guide member.

15. The electronic device of claim 1, further comprising:
a second opening that is formed in the housing and is positioned parallel to the opening; and
a connection device that is arranged within the housing to correspond to the second opening,
wherein the second member is mounted on the connection device.

16. The electronic device of claim 15, wherein the second member includes:
a protrusion;
a mounting portion that is formed around the protrusion; and
a binding recess that is formed between the protrusion and the mounting portion, and
wherein a portion of the connection device is engaged with the binding recess.

17. The electronic device of claim 16, wherein the second member is made of a transparent material and positioned adjacent to the opening.

18. The electronic device of claim 16, wherein the first member is attached to an inner surface of the mounting portion and is visually exposed to the outside of the housing through the opening.

19. The electronic device of claim 18, further comprising:
an optical member that is attached to an outer surface of the mounting portion in a position corresponding to that of the first member.

20. The electronic device of claim 16, wherein the second member further includes an accommodation recess that is formed on an inner surface of the mounting portion, and the first member is attached to the accommodation recess.
